(19) United States
(12) Patent Application Publication
(10) Pub. No.: US 2025/0335963 A1
(43) Pub. Date: Oct. 30, 2025

(54) ARCHITECTURE FOR PERSONALIZED BEAUTY EXPERIENCE USING LARGE LANGUAGE MODEL

(71) Applicant: L'Oreal, Paris (FR)

(72) Inventors: Soheil SEYFAIE, Toronto (CA); Ruowei JIANG, Toronto (CA); Edgar MAUCOURANT, Toronto (CA); Jeffrey HOUGHTON, Toronto (CA); Anastasia KOLESNIKOV, Toronto (CA)

(73) Assignee: L'Oreal, Paris (FR)

(21) Appl. No.: 18/651,084

(22) Filed: Apr. 30, 2024

(51) Int. Cl. G06Q 30/0601; G06N 3/0895

(52) U.S. Cl. CPC G06Q 30/0631; G06Q 30/015; G06Q 30/0641

(57) ABSTRACT

A computer system transmits user input and contextual information to a large language model (LLM) and requests the LLM to confirm the input text relates to one or more beauty topics. Based on the confirmation, the system requests the LLM to provide a response to the input text to be presented to a user. The response relates to the beauty topic(s) and is based on the input text and contextual information. The confirmation may include requesting the LLM to provide one or more classifications of the input text, which indicate that the input text relates to the beauty topic(s). The system may request the LLM to provide a summary of the input text, generate a vector representation, and identify matches for the vector representation of user input among other vector representations in the database (e.g., for relevant products or content).

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system perform operations comprising transmitting user input and contextual information for the user input to a large language model (LLM); requesting the LLM to provide a confirmation that the user input relates to one or more beauty topics; receiving the confirmation that the user input relates to the one or more beauty topics from the LLM; based on the confirmation, requesting the LLM to provide a response to the user input to be presented to a user, wherein the response relates to the one or more beauty topics and is based at least in part on the user input and the contextual information; and receiving the response from the LLM.

In another aspect, a computer system perform operations comprising receiving user input provided by a user via a user interface presented at a client computing device; obtaining contextual information for the user input; transmitting the user input and the contextual information for the user input to an LLM; requesting the LLM to provide a confirmation that the user input relates to one or more beauty topics; receiving the confirmation that the user input relates to the one or more beauty topics from the LLM; based on the confirmation, requesting the LLM to provide a response to the user input to be presented to a user, wherein the response relates to the one or more beauty topics and is based at least in part on the user input and the contextual information; receiving the response from the LLM; and causing the response to be presented to the user via the user interface.

In some embodiments, the user input includes text input or voice input. In some embodiments, the user interface comprises a chat interface, and the response comprises text presented to the user in the chat interface. In some embodiments, the user interface comprises a skin analysis request user interface element, and operations further comprise receiving an indication of activation of the skin analysis request user interface element; and, responsive to the indication of activation of the skin analysis request user interface element, obtaining a digital model of a face of the user; and requesting the LLM to generate a product recommendation or a care routine recommendation based at least in part on the digital model of the face. In some embodiments, the user interface comprises a product information user interface element configured to allow the user to view information corresponding to recommended products, and the operations further comprise requesting the LLM to generate one or more product recommendations; receiving the one or more product recommendations from the LLM; and causing a client computing device to present the one or more product recommendations to the user via the product information user interface element. In some embodiments, the user interface comprises a content selection user interface element configured to allow the user to view information corresponding to recommended content, and the operations further comprise requesting the LLM to generate one or more content recommendations; receiving the one or more content recommendations from the LLM; and causing a client computing device to present the one or more content recommendations to the user via the content selection user interface element.

In some embodiments, requesting the LLM to provide the confirmation that the user input relates to the one or more beauty topics comprises requesting the LLM to provide one or more classifications of the user input, receiving the confirmation that the user input relates to the one or more beauty topics comprises receiving the one or more classifications of the user input from the LLM, and the one or more classifications indicate that the user input relates to one or more beauty topics. In some embodiments, requesting the LLM to provide one or more classifications of the user input comprises requesting the LLM to provide a first classification of the user input; receiving the first classification of the user input from the LLM, wherein the first classification indicates that the user input relates to the one or more beauty topics; and, responsive to the first classification indicating that the user input relates to the one or more beauty topics, requesting the LLM to provide a second classification of the user input that further defines the one or more beauty topics. In such embodiments, requesting the LLM to provide the response to the user input may be based on both the first classification and the second classification.

In some embodiments, the operations further comprise requesting the LLM to provide a summary of the user input and may also comprise receiving the summary of the user input from the LLM and generating a vector representation of the user input. In some embodiments, the operations further comprise comparing the vector representation of the user input with vector representations of other vector representations in a vector database and identifying a near-neighbor match for the vector representation of the user input among the other vector representations in the vector database.

In some embodiments, the operations further comprise obtaining a digital model of a face of the user and requesting the LLM to generate a product recommendation or a care routine recommendation based at least in part on the digital model of the face. The digital model of the face may include a plurality of skin features including blemish information, hyper-pigmentation information, skin texture information, skin tone information, or other information, or a combination thereof.

In some embodiments, the computer system includes or communicates with a client computing device comprising a camera. In such embodiments, the operations may further comprise causing the client computing device to request activation of the camera to capture one or more digital images; receiving the one or more captured digital images; and generating a digital model of the face of the user based at least in part on the one or more captured digital images. In some embodiments, the operations further comprise requesting the LLM to generate a product recommendation or a care routine recommendation based at least in part on the digital model of the face.

Computer-implemented methods, computer-readable media, computing devices and computer systems are disclosed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that provides a high-level overview of a computer system according to aspects of the present disclosure;

FIG. 2 is a block diagram that illustrates an example embodiment of data flow and logic in a back-end server computer system according to aspects of the present disclosure;

FIG. 3 is a block diagram that illustrates an example embodiment of a client computing device according to aspects of the present disclosure;

FIG. 4A-4D are screenshot diagrams of an illustrative user interface, in accordance with a described embodiment;

FIG. 5 is a flowchart that illustrates an example embodiment of a method of using an LLM to obtain responses to user input on beauty topics according to aspects of the present disclosure;

FIG. 6 is a block diagram that illustrates aspects of an exemplary computing device appropriate for use with embodiments of the present disclosure.

### DETAILED DESCRIPTION

Described embodiments include methods and systems for providing personalized beauty recommendations based on user preferences and needs as well as available products. Described embodiments use real-time data from direct interaction with users as well as product information to provide highly personalized recommendations using a large language model (LLM) approach. Described embodiments are further designed to avoid hallucination in this context, which is a major challenge with LLMs.

In an illustrative usage scenario, a user interacts with the system with a smartphone, laptop, or other client computing device. The user may log in to the system with account credentials or use the system as a guest. In some embodiments, the system can access user information, chat history, and the like, and can use such information to customize the user's interaction with the system. A user interface provides a mechanism for the user to interact with the system (e.g., via voice or chat interactions with an LLM-based chatbot). In the user interface, the user is presented with one or more options for interaction, such as example questions to ask the system or a general invitation to ask any question. The user then asks questions or makes statements via the user interface, and those questions or statements are provided as input to the system for further analysis. In an embodiment, the system is configured to suggest taking a self-portrait photo for further analysis if knowledge of the user's appearance or condition of the user's hair or skin is helpful to inform the system's response. In such an embodiment, the system analyzes the photo to determine characteristics (e.g., gender, color of hair, shape of head, color of eyes, skin tone, etc.) which can be used to provide personalized responses or recommendations.

The system is able to work with a general purpose LLM (e.g., GPT-3 or GPT-4, available from OpenAI Inc., LaMDA/Bard, available from Google LLC, etc.), which need not be specially trained on beauty topics. In some embodiments, the system specially controls and customizes interactions with the LLM to improve performance and reduce the chance of hallucinations or inaccurate answers. In this way, the system improves on previous general purpose LLM-based chatbots in important ways. In some embodiments, when the user begins a chat, the system prompts the LLM to answer from the perspective of a highly skilled beauty consultant, which helps to ensure that any responses are provided in a style that the user expects and that the responses remain focused on beauty topics. When the user asks a question or makes a statement, the system appends contextual information. In some embodiments, the contextual information is provided in the form of prompts to provide context for the question or statement, such as special definitions or constraints to be considered by the LLM, user profile information (e.g., preferences, characteristics, products used, etc.), summaries of past conversations, or other contextual information.

The system uses the LLM to classify the question and determine if the question is well-posed. If the question is not well-posed, the system poses clarifying questions to the user. If the question is well-posed and the LLM can answer the question, the LLM provides the answer to the system, and the system presents the answer to the user. Classification of the question helps to ensure that answers are provided using appropriate resources. For example, if the user asks about skin concerns, the system uses skin treatment information in order to provide the answer. The system uses a similar approach for other types of questions including makeup questions, hair care questions, and nail care questions. If the question can be better answered by analyzing a photo of the user, the system can request access to the user's stored photos or camera. User photos can be analyzed to assess skin concerns of the user and provide personalized care routines or product recommendations. In some embodiments, the camera is used for analyzing makeup, hair, or nails in real time, which can include the use of augmented reality virtual try-on applications. In some embodiments, the system obtains additional information such as location information, which can then be used to inform responses provided to the user. For example, location information can be used to identify convenient stores for purchasing products, to assess the user's environmental conditions (e.g., humidity, temperature, UV conditions, etc.) to inform product recommendations or care routine recommendations, or for other purposes.

In some embodiments, the system presents a user interface to the user which, in addition to chat functionality, allows the user to view product information, view tutorial or promotional content, identify locations for purchasing products in stores or salons, purchase products via a website, or perform other tasks.

LLMs described herein in the context of embodiments may be single-mode (e.g., receiving text input and responding with text responses) or multi-modal (e.g., receiving text and images or other modes of input and providing text and images or other modes of output).

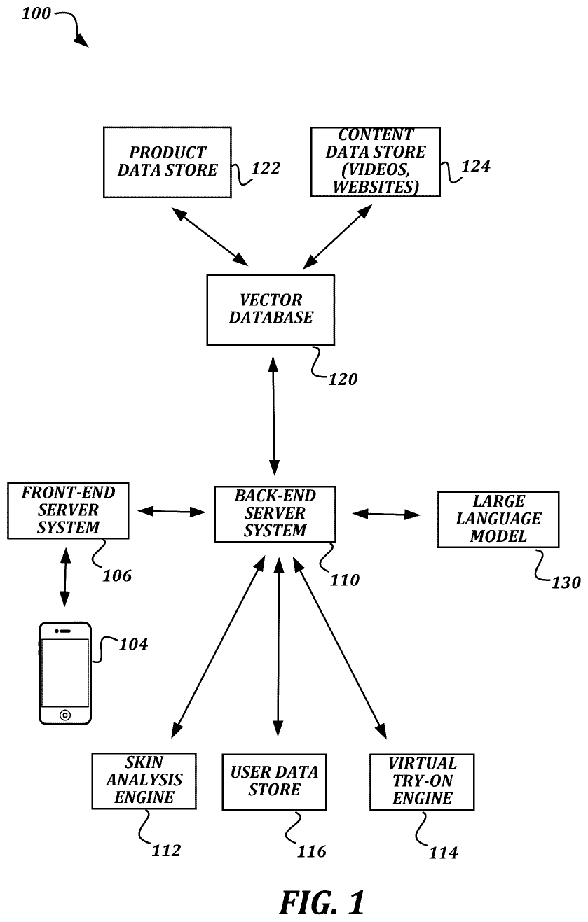

FIG. 1 is a block diagram that illustrates a system in which various aspects of the present disclosure may be implemented. As shown, the system 100 includes one or more client computing devices 104, a front-end server system 106, a back-end server system 110, a skin analysis engine 112, a virtual try-on engine 114, a user data store 116, a vector database 120, a product data store 122, a content data store 124, and an LLM 130.

The client computing device 104 may be used by a consumer to interact with other components of the system 100, such as the front-end server system 106. In an embodiment, the client computing device 104 is a mobile computing device such as a smart phone or a tablet computing device. However, any other suitable type of computing device capable of communicating via the network and presenting a user interface, including but not limited to a desktop computing device, a laptop computing device, augmented reality/virtual reality glasses or goggles, a dedicated AI-enhanced device such as the Humane AI Pin or Rabbit R1 device, a smart speaker, or a smart watch (or combinations of such devices) may be used.

The front-end server system 106 includes one or more server computers that provide an interface for client computing device 104 to access functionality of the system 100. In an embodiment, the front-end server system 106 provides a web interface through which an end user may access such functionality, e.g., via a web browser or a dedicated client application. In an embodiment, the front-end server system 106 is responsible for generating the user interface and communicating the user's requests to the back-end server system 110. An illustrative user interface is described in further detail below.

In an embodiment, the front-end server system 106 also provides access to a digital personal care application, which may be implemented by or accessed via back-end server system 110. The application may provide e-commerce functionality for shopping, payment, and delivery options for products or services. In an illustrative scenario, a consumer orders a service and product online through a virtual storefront for a service provider, such as a salon. The consumer may access the virtual storefront via the front-end server system 106, which may then submit orders to the back-end server system 110 for subsequent processing and fulfillment. Fulfillment may include delivery of an ordered product (e.g., to the consumer's address or to the service provider's location ahead of the consumer's scheduled appointment). Fulfillment may also include delivery of product information or digital content to client computing device 104.

In an embodiment, the front-end server system 106 and/or back-end server system 110 implements an application programming interface (API) that allows service providers, manufacturers, and others to offer services and products through the application. As an example, the application may provide functionality for connecting consumers with experts, retailers, or service providers via audio calls, video calls, instant messaging, email, or the like, to receive advice or request information about products or services. The application may provide a platform for experts, service providers, or retailers to provide content such as videos, articles, or the like to existing customers or prospective customers.

The back-end server system 110 includes one or more server computers. As illustrated, the back-end server system 110 communicates with a skin analysis engine 112, a virtual try-on engine 114, a user data store 116, a vector database 120, and an LLM 130. In an embodiment, the vector database 120 ingests product information from data sources such as the product data store 122 (e.g., product descriptions, product ingredients) the content data store 124 (e.g., product safety information, reviews, video tutorials, promotional videos, websites). The vector database 120 stores embeddings (vector data representation) that represents this content. For videos, audio is transcribed to text (e.g., using the Whisper machine learning model, available from OpenAI Inc.), and embeddings of these transcriptions are added to the vector database 120. On the user side, a user's prompts or queries are also represented as embeddings, which allows the user's prompts or queries to be compared with embeddings that are already in the vector database. Because these embeddings are numeric in nature, it is possible to search for content that is relevant to a user query by searching for “near neighbors” of an embedding of the user query. This allows retrieval of relevant documents, videos, or other content in the vector database 120. In some embodiments, embeddings of user's prompts or queries are also added to the vector database 120 to further enrich the database.

In an embodiment, the LLM 130 serves several roles in the system 100. In one illustrative role, the system uses the LLM 130 to summarize user prompts or queries, thereby distilling them into a form that can be more easily and accurately transformed into an embedding. For example, the back-end server system 110 may provide to the LLM 130 a user query along with a prompt to summarize that query in two or three sentences, which can be more easily transformed into an embedding that accurately represents the user's query. Additional functionality of the LLM 130 is described below.

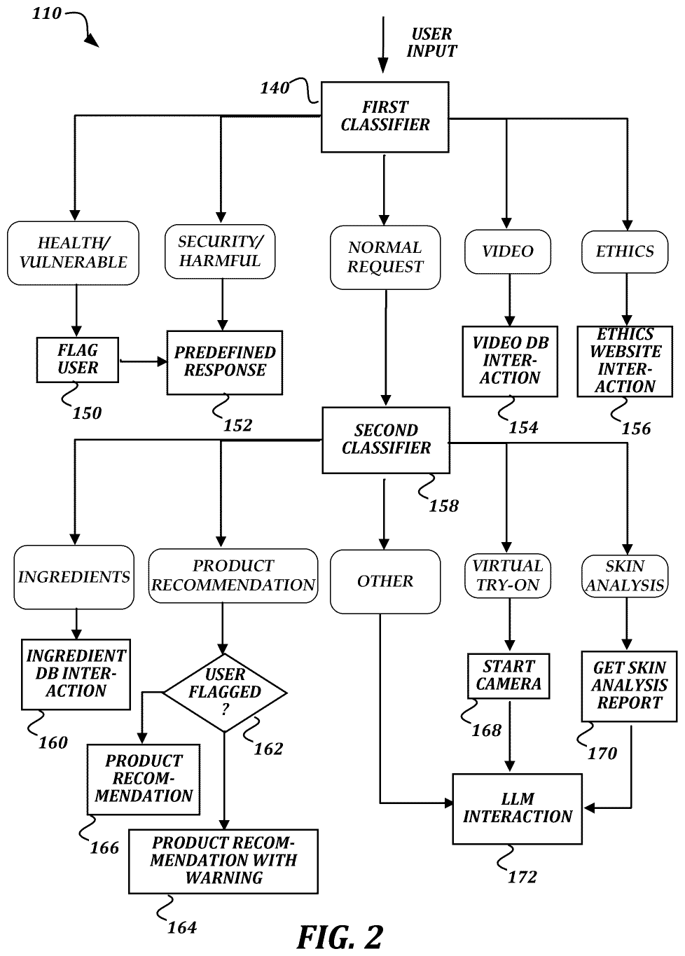

FIG. 2 is a block diagram that illustrates an example embodiment of a user interaction data flow and logic in the back-end server system 110 according to aspects of the present disclosure. The illustrative design depicted in FIG. 2 depicts that expected functioning of the chatbot aspects of the system 100 and helps to ensure that the system is used safely, provides relevant results, and reduces the chance of hallucination by the LLM 130. In the example shown in FIG. 2, user input is provided to a first classifier 140 which classifies user input into different categories, and may also be referred to as an input classifier. In an embodiment, the first classifier 140 achieves this by providing the user input to the LLM 130 and requesting the LLM 130 to categorize the input as one of the following: “Health,” “Vulnerable,” “Harmful,” “Security,” “Normal,” “Video,” or “Ethics.” Alternatively, the first classifier 140 can be implemented as a natural language classifier specifically designed to classify the input without requiring access to the LLM 130. These classifications can be defined as follows:

Normal: The request is related to beauty advice and is politically neutral, does not involve ethical concerns, and is not offensive.

Health: The request suggests that the user requires medical attention, has mental health issues (such as depression or severe anxiety), has severe physical health issues, or is pregnant. This category does not include standard forms of skin problems like acne, eczema, redness or breakouts.

Vulnerable: The request suggests that the user is a vulnerable individual (such as a child or someone addicted to drugs) who may be susceptible to manipulation.

Harmful: The request is offensive (e.g., racist or discriminatory), illegal, or violent, or overtly political, or suggests using products in potentially malicious ways.

Security: The request raises data privacy or security issues, or attempts to hijack the chatbot (e.g., to get information about its configuration or to change its functionality or role).

Ethics: The request is about company ethics or values.

Videos: The request is to access a video.

In an embodiment, the back-end server system 110 instructs the LLM 130 accordingly by providing one or more additional prompts that define these categories, which the LLM 130 uses to categorize the user input. The back-end server system 110 may provide additional prompts to the LLM 130, such as a prompt that the LLM 130 return not only a category but also a reason for the input being assigned to that category.

In the example shown in FIG. 2, if the LLM 130 categorizes the input as “Health” or “Vulnerable,” the back-end server system 110 flags the user accordingly in process block 150 along with the reason for flagging (e.g., likely pregnant user as a reason for categorizing as “Health”; likely child user as a reason for categorizing as “Vulnerable”) and provides a predefined response to the user at process block 152. The flag information can be added to a profile for that user (e.g., in user data store 116). In future interactions with the user, the back-end server system 110 considers this information. In an illustrative scenario, a product recommendation considers the previous flag in preparing the response and displays a warning message to the user. If the LLM 130 categorizes the input as “Harmful” or “Security,” the back-end server system 110 causes predefined messages to be displayed in process block 152. If the LLM 130 categorizes the input as “Video” or “Ethics,” the back-end server system 110 obtains corresponding information from video database or the ethics website at process blocks 154 and 156, respectively.

For input that is initially classified as a “Normal Request,” the back-end server system 110 performs a further level of classification at second classifier 158. In an embodiment, the second classifier 158 achieves this by providing the request (which has now been categorized as a “Normal Request” by the first classifier 140) to the LLM 130 and prompting the LLM 130 to categorize the request as one of the following: “Ingredients,” “Product Information,” “Virtual Try-on,” “Skin Analysis,” or “Other.” Thus, the second classifier 158 also may be referred to as a request classifier. This further level of classification helps to reduce the chance of hallucination or inaccurate results. In an embodiment, the back-end server system 110 instructs the LLM 130 accordingly by providing one or more prompts that define these categories, which the LLM 130 uses to further categorize the user input. Alternatively, the second classifier 158 can be implemented as a natural language classifier specifically designed to classify the request without requiring access to the LLM 130. These further classifications can be defined as follows.

Ingredients: A request for information about ingredients in a product.

Product Recommendation: A request for a recommendation for a product.

VTO request: A request for a virtual try-on session.

Skin Analysis: A request for skin analysis.

Other: Catch-all category for requests that do not fit into any of the other categories.

In the example shown in FIG. 2, if the LLM 130 categorizes the request as “Ingredients,” the back-end server system 110 obtains corresponding information from an ingredients database at process block 160. In an embodiment, the back-end server system 110 retrieves the appropriate documents specifying ingredients for a product and sends them to the user.

If the LLM 130 categorizes the request as “Product Recommendation,” the back-end server system 110 determines whether the user was previously flagged (e.g., as “Health” or “Vulnerable”) at decision block 162. In the example shown in FIG. 2, if the user was previously flagged, the back-end server system 110 obtains a modified product recommendation at process block 164, such as by sending the user's request to the LLM 130 with additional context about the flag to restrict and/or provide a warning with the recommendation. Otherwise, the back-end server system 110 obtains a product recommendation at process block 166, such as by sending the user's request to the LLM 130, without such warnings.

If the LLM 130 categorizes the request as “VTO Request,” the back-end server system 110 may cause a camera on the client computing device 104 to start at process block 168 and provide corresponding required product information to an app on the client computing device 104 to start a virtual try-on process (e.g., by running virtual try-on engine 114 to try a cosmetic product in an augmented reality application). The virtual try-on process may include an interaction with the LLM 130 at process block 172, such as using a chat interface to obtain a product information and virtually applying the recommended product in the virtual try-on process.

If the LLM 130 categorizes the request as “Skin Analysis,” the back-end server system 110 may cause a camera on the client computing device 104 to start at process block 168 and/or process a user's self-portrait photo to obtain a skin analysis report (e.g., by skin analysis engine 112) at process block 170. The skin analysis process may include an interaction with the LLM 130 at process block 172, such as using a chat interface to transmit a skin analysis report and obtain a product or care routine recommendation from the LLM 130. If the LLM 130 categorizes the request as “Other,” the back-end server system 110 requests the LLM 130 to provide a response that can be sent to the user (process block 172). Thus, for some categories, the LLM 130 is requested to provide a full response to the user's query, rather than simply classifying the query.

The back-end server system 110 may use prompt engineering to increase the chance of useful, topical responses. For example, the back-end server system 110 may transmit a user's query to the LLM 130 along with one or more prompts that supplement or constrain the query, such as user profile information, user preferences, or instructions for how to respond to the query (e.g., recommend only products of a specified type or from a specific company). The back-end server system 110 may further request the LLM 130 to summarize the user query, which is an effective technique for vector database embedding (as described above). In some embodiments, multiple LLMs may be used to cross-check responses and reduce the chances of hallucination or inaccurate responses that may occur with a single LLM working independently.

Referring again to FIG. 1, in an embodiment, the virtual try-on engine 114 allows consumers to apply different looks or characteristics of a product, e.g., using augmented reality techniques, to modify an image of the consumer's face, hair, skin, etc. This technology also may be used to perform color matching, compare products with other products, test variations in characteristics such as coverage, color, finish, etc. In an embodiment, the skin analysis engine 112 generates a digital model (e.g., based on one or more digital images or scans) of the face of a human subject. In an embodiment, the skin analysis engine 112 obtains one or more digital images or scans from the client computing device 104, such as a smart phone with an integrated digital camera. In such an embodiment, these images or scans are captured by the client computing device 104 and uploaded to the skin analysis engine 112, which generates the digital model and detects clinical signs (e.g., of aging) and/or skin concerns of the user. In an embodiment, the digital model includes a highly accurate model of facial characteristics and features, including lip and eye edges, iris size and location, skin features including spots, texture, and wrinkles, and the like. It will be understood that the skin characteristics and features described herein are only examples, and that other characteristics or features or combinations of such characteristics or features are also desirable and are within the scope of the present disclosure. In an embodiment, the source images are captured and the digital models are generated using Modiface software available from Modiface, Inc.

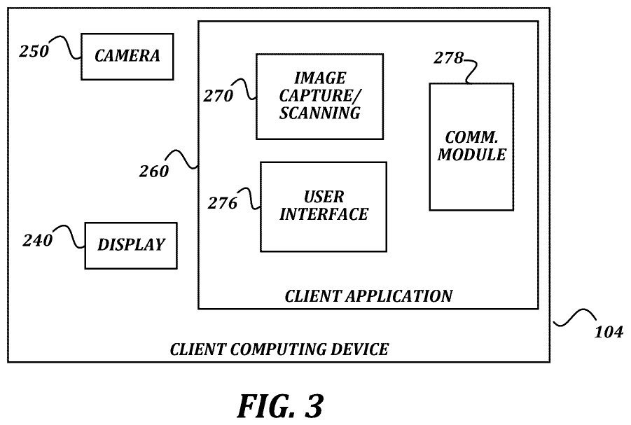

FIG. 3 is a block diagram that illustrates an example embodiment of a client computing device 104 according to various aspects of the present disclosure. FIG. 3 depicts a non-limiting example of client computing device features and configurations; many other features and configurations are possible within the scope of the present disclosure.

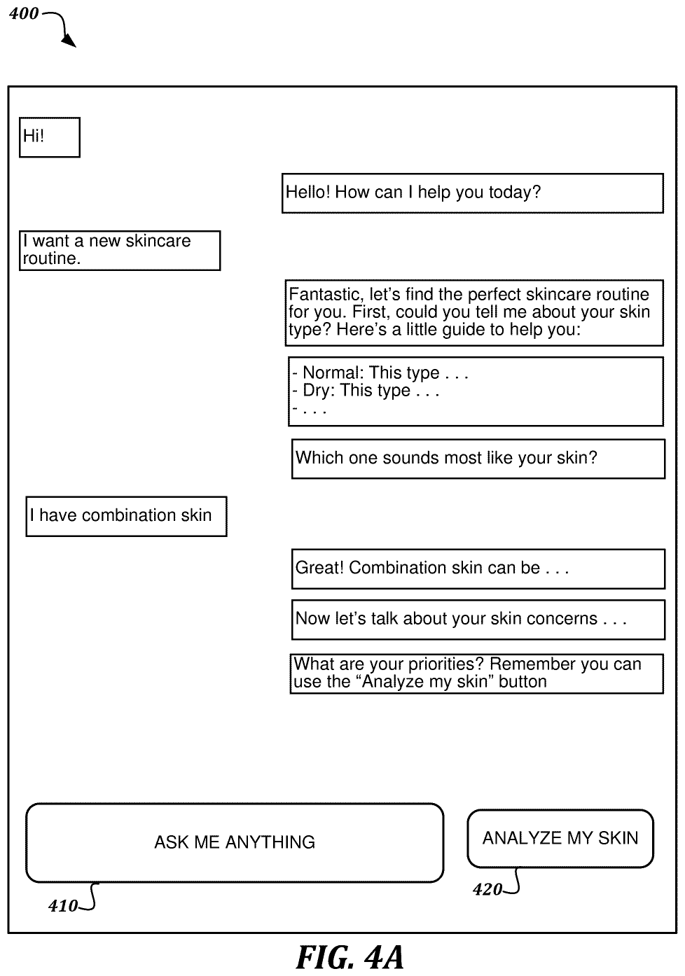

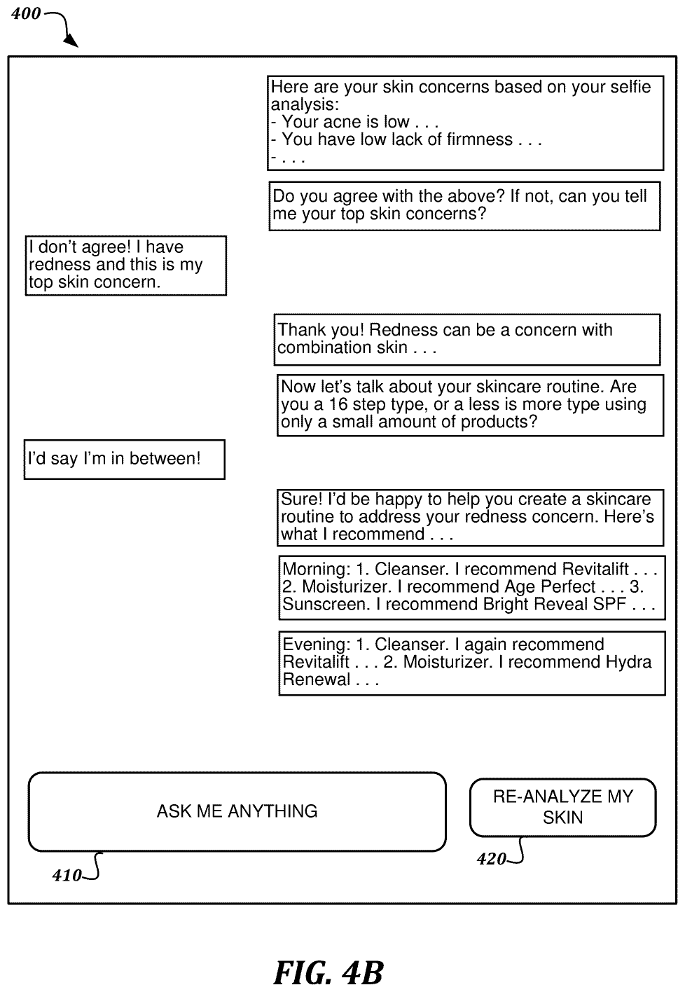

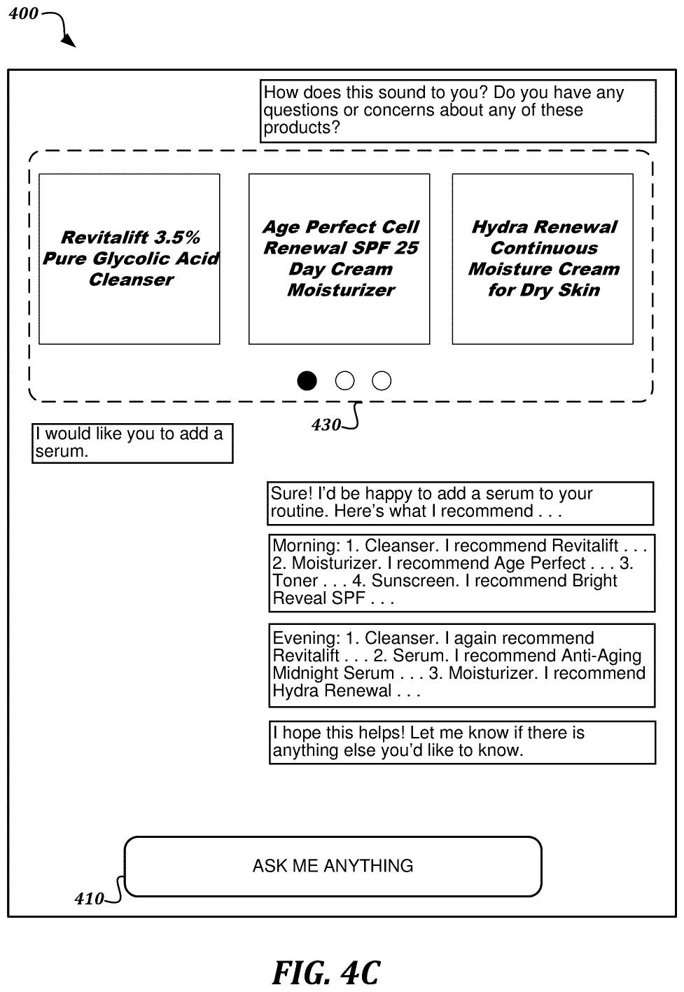

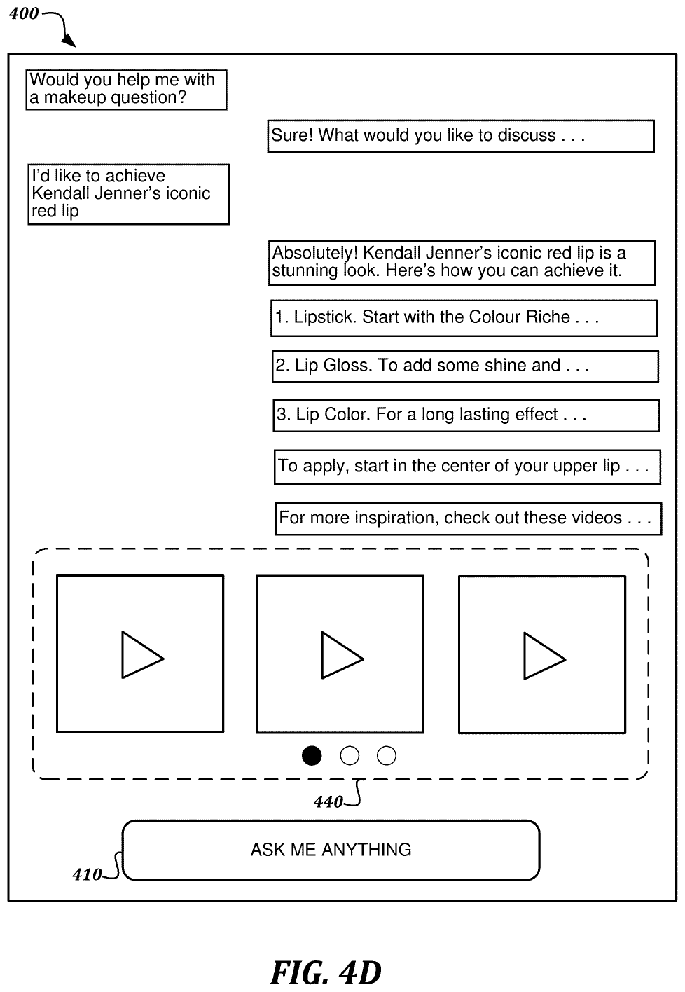

In the example shown in FIG. 3, the client computing device 104 includes a camera 250 and a client application 260. The client application 260 includes a user interface 276, which may include interactive functionality such as data collection or voice/chat elements, tools for entering or editing user preferences, tutorials, virtual “try-on” functionality for virtually testing different products or cosmetics, or other elements. In an embodiment, the user interface 276 provides functionality for exploring custom products recommended by care professionals, such as custom product formulations (e.g., custom formulations of hair treatment products, makeup products, etc.), custom combinations of products to achieve a particular look or effect, variations in products (e.g., color, finish, texture), and the like. Visual elements of the user interface 276 are presented on a display 240, such as a touchscreen display. Customized content, such as customized product recommendations and skin care routines, may be obtained by the client computing device 104 (e.g., from the back-end server system 110) and presented via the user interface 276. Details of an illustrative user interface are described below with reference to FIGS. 4A-4D.

In an embodiment, the client application 260 also includes an image capture/scanning module 270, which is configured to capture and process digital images (e.g., color images, depth images, etc.) or scans. In an embodiment, the digital images or scans are transmitted to back-end server system 110 or some other external computer system where digital skin models are generated. Alternatively, the digital models are generated at the client computing device 104 or at some other location. In an embodiment, the digital models include 3D topology and texture information, which can be used for reproducing an accurate representation of the user's facial structure and overall appearance, as well as for skin diagnostics (e.g., to detect blemishes, areas of hyper-pigmentation, visible pores, etc.). In an embodiment, the user interface 276 includes user interface elements to assist in accurately capturing the digital images or scans on which these digital skin models are based, such as graphical guides to center the users face in a self-portrait photo, visual or audio reminders to adjust ambient lighting or hold the camera steady, or the like.

In an embodiment, a communication module 278 of the client application 260 is used to prepare information for transmission to, or to receive and interpret information from other devices or systems, such as the front-end server system 106. Such information may include captured digital images, scans, or video, skin care device settings, custom care routines, user preferences, user identifiers, device identifiers, or the like.

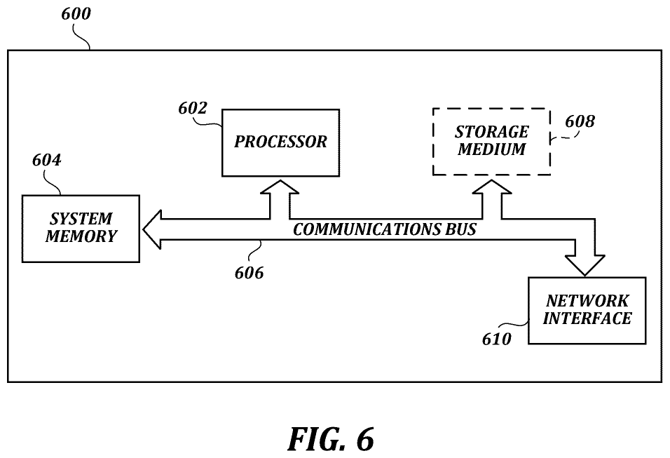

Other features of client computing devices are not shown in FIG. 3 for ease of illustration. A description of illustrative computing devices is provided below with reference to FIG. 6.

The devices shown in FIGS. 1-3 or other devices used in described embodiments may communicate with each other via a network (not shown), which may include any suitable communication technology including but not limited to wired technologies such as DSL, Ethernet, fiber optic, USB, and Firewire; wireless technologies such as WiFi, WiMAX, 3G, 4G, LTE, 5G, and Bluetooth; and the Internet. In general, communication between the components of the systems in FIG. 1 or other computing devices may occur directly or through intermediate devices.

Many alternatives to the arrangement disclosed and described with reference to FIGS. 1-3 are possible. For example, functionality described as being implemented in multiple components may instead be consolidated into a single component, or functionality described as being implemented in a single component may be implemented in multiple illustrated components, or in other components that are not shown in FIGS. 1-3. As another example, devices in FIGS. 1-3 that are illustrated as including particular components may instead include more components, fewer components, or different components without departing from the scope of described embodiments.

In general, the word “engine,” as used herein, refers to logic embodied in hardware or software instructions written in a programming language, such as C, C++, COBOL, JAVA™, PHP, Perl, HTML, CSS, Javascript, VBScript, ASPX, Microsoft .NET™, and/or the like. An engine may be compiled into executable programs or written in interpreted programming languages. Software engines may be callable from other engines or from themselves. Generally, the engines described herein refer to logical modules that can be merged with other engines or divided into sub-engines. The engines can be stored in any type of computer-readable medium or computer storage device and be stored on and executed by one or more general purpose computers, thus creating a special purpose computer configured to provide the engine or the functionality thereof.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

Aspects of an illustrative user interface will now be described with reference to FIGS. 4A-4D. It will be understood that the present disclosure also encompasses many alternative user interface features and techniques that vary from those described below.

FIG. 4A depicts a screenshot of an illustrative user interface 400, in accordance with a described embodiment. In the example shown in FIG. 4A, the user interface 400 includes user interface elements in the form of a text box 410 (labeled “Ask Me Anything”) in which a user can type statements or questions and skin analysis request element (e.g., button 420) to initiate a skin analysis process.

The user interface 400 also includes a chat interface, which presents a user's inputs alongside the system's responses. Alternatively, a voice interface or a combination of visual/text chat and voice interface can be used.

In an embodiment, the user's inputs are processed according to the logic and data flow depicted in FIG. 2. In the example shown in FIG. 4A, the chat begins with a general greeting typed by the user (“Hi”). In an embodiment, this greeting is processed by the first classifier 140 by sending the input text to the LLM 130, which classifies the input as a “Normal Request.” The input text is then processed by the second classifier 158 by sending the input text to the LLM 130, further which classifies the prompt as “Other.” The input text is then sent to the LLM 130 for a full response at process block 172, and the LLM returns a response in the chat interface. (“Hello! How can I help you today?”)

As shown in FIG. 4A, the user continues the interaction with further text. (“I want a new skincare routine.”) In an embodiment, this input text is processed by the first classifier 140 by sending the prompt to the LLM 130, which classifies the input text as a “Normal Request.” The input text is then processed by the second classifier 158 by sending the prompt to the LLM 130, further which classifies the input text as “Other.” The input text is then sent to the LLM 130 for a full response at process block 172, and the LLM 130 returns a response in the chat interface. In the example shown in FIG. 4A, the LLM 130 responds by agreeing to help with a new skin care routine and requesting information about the user's skin type. In an embodiment, the decision by the LLM 130 to respond with a query for more information from the user is informed by pre-training or prompting the LLM 130 to respond initially to queries about skin care routines with a follow up question to determine the user's skin type. As shown in FIG. 4A, the user continues the interaction with further input that describes the user's skin type. (“I have combination skin.”) This input text is also classified as a “Normal Request” and “Other,” and the LLM 130 responds with information about combination skin and a request for information about the user's skin concerns and priorities. The LLM 130 also suggests skin analysis as a next step and reminds the user that the button 420 can be used to initiate a skin analysis process. In an embodiment, the decision by the LLM 130 to respond in this way is informed by pre-training or prompting the LLM 130 to respond initially to statements about skin type with a follow up question regarding skin concerns and/or a suggestion to initiate a skin analysis process.

FIG. 4B depicts another screenshot of the illustrative user interface 400, in accordance with a described embodiment. In the example shown in FIG. 4B, the user has activated the button 420, which executes a skin analysis process. Such a process may include requesting the user to take a new self-portrait photo or select a previously captured photo from a photo library. The self-portrait photo is analyzed by face scan software (e.g., skin analysis engine 112) to generate a digital model of the user's face. In an embodiment, the digital model includes clinical signs of aging, skin concerns, skin characteristics and features. In an embodiment, the characteristics and features include blemishes, areas of hyper-pigmentation, texture, or wrinkles, or other features or combinations thereof.

In the example shown in FIG. 4B, the back-end server system has transmitted results of the skin analysis to the LLM 130, which responds by summarizing those results and asking if the user agrees with the summary. In an embodiment, the decision by the LLM 130 to respond with a summary and request confirmation is informed by pre-training or prompting the LLM 130 to respond to skin analysis results in this way. As shown in FIG. 4B, the user continues the interaction with further input that expresses disagreement with the summary of skin concerns and provides a different skin concern. (“I have redness and this is my top skin concern.”) This input text is classified as a “Normal Request” and “Other,” and the LLM 130 responds with information about redness as a skin concern for combination skin. The LLM 130 also provides a suggestion to discuss the user's skincare routine. In an embodiment, the decision by the LLM 130 to respond in this way is informed by pre-training or prompting the LLM 130 to respond initially to statements about skin type with a follow up question regarding skin concerns and/or a suggestion to initiate a skin analysis process. The decision by the LLM 130 may be further informed by the user's previous request in FIG. 4A, which can be stored in the chat history, to discuss a new skincare routine.

In an embodiment, the chat history is processed by the LLM 130 to allow the LLM 130 to formulate a response. Different approaches to processing of the chat history can be used. As one example, the LLM 130 summarizes a chat history and uses the summary that it generates to formulate a response, but does not necessarily store the summary that it generates. As another example, user input and a summary of the LLM response is saved in a storage area, such as a database, and this summary can be retrieved from the storage area as needed.

As shown in FIG. 4B, the user continues the interaction with a further statement regarding level of complexity of the user's skincare routine. (“I'd say I'm in between!”) In an embodiment, this statement is processed by the first classifier 140 and second classifier 158 by sending the statement to the LLM 130, which classifies the statement as a “Normal Request” and “Other.” On this basis, the system requests a full response at process block 172, and the LLM 130 returns a response in the chat interface. In the example shown in FIG. 4B, the LLM 130 responds by agreeing to help with a new skin care routine. In this example, instead of requesting information about the user's skin type, as was done in FIG. 4A, the LLM responds with specific product and care routine recommendations. In an embodiment, the decision by the LLM 130 to respond in this way is informed by pre-training or prompting the LLM 130 to provide product and/or routine recommendations once information about the user's skin concerns, skin type, and skin condition have been obtained. In an embodiment, the back-end server system 110 retrieves product information from the vector database 120 and sends the product information to the LLM 130 before the LLM provides product recommendations, in order to improve the chance of accurate recommendations and reduce the chance of hallucination by the LLM 130.

FIG. 4C depicts another screenshot of the illustrative user interface 400, in accordance with a described embodiment. In the example shown in FIG. 4C, the LLM 130 asks the user's opinion on the recommended products and skin care routine. (“How does this sound to you? Do you have any questions or concerns about any of these products?”) The user interface 400 also presents a product information user interface element 430, which is configured to allow the user to view information corresponding to recommended products. In the example shown in FIG. 4C, the product information user interface element 430 is configured to allow the user to scroll through (e.g., horizontally or vertically) icons corresponding to the recommended products. In an embodiment, user interaction with these icons (e.g., by clicking or tapping) causes product pages with additional information (e.g., ingredients, reviews, pricing information, purchase information, etc.) to be displayed. In an embodiment, the specific product recommendations by the LLM 130 are informed by embedding a representation of the user information that has been obtained so far (e.g., skin analysis results, skin concerns) and comparing the resulting embedding with previously stored embeddings representing products in a vector database (e.g., vector database 120). The recommendations may be further informed by pre-training or prompting the LLM 130 to constrain the product recommendations, such as by limiting recommended products to a particular brand.

As shown in FIG. 4C, the user continues the interaction with a further statement requesting that a serum be added. (“I would like you to add a serum.”) In this example, the LLM 130 responds with specific product and care routine recommendations that include a serum. In an embodiment, the decision by the LLM 130 to respond in this way is informed by pre-training or prompting the LLM 130 to update product and/or routine recommendations once an initial set of products and/or routine recommendations have been presented to the user.

FIG. 4D depicts another screenshot of the illustrative user interface 400, in accordance with a described embodiment. In the example shown in FIG. 4D, user continues the interaction with further input text requesting a discussion about makeup. (“Would you help me with a makeup question?”) In an embodiment, this question is processed by the first classifier 140 and second classifier 158 by sending the input text to the LLM 130, which classifies the input text as a “Normal Request” and “Other.” The system requests a full response at process block 172, and the LLM 130 returns a response in the chat interface. (“Sure! What would you like to discuss?”) The user continues the interaction with a further statement. (“I'd like to achieve Kendall Jenner's iconic red lip.”) In an embodiment, this statement is processed by the first classifier 140 and second classifier 158 by sending the statement to the LLM 130, which classifies the prompt as a “Normal Request” and “Other.” The system requests a full response at process block 172, and the LLM 130 returns a response in the chat interface. In the example shown in FIG. 4D, the LLM 130 responds by agreeing to help with achieving the desired look and provides specific product recommendations. In an embodiment, the decision by the LLM 130 to respond in this way is informed by pre-training or prompting the LLM 130 to provide product and/or routine recommendations once information about the user's skin concerns, skin type, and skin condition have been obtained. The user interface 400 also presents a content selection user interface element 440, which is configured to allow the user to view content (e.g., videos or websites) that relate to the desired look, such as by scrolling horizontally through icons corresponding to the content. In an embodiment, user interaction with these icons (e.g., by clicking or tapping) causes videos to play (e.g., in a dedicated video player or a web browser) or other content such as websites to be displayed. In an embodiment, the specific product and content recommendations by the LLM 130 are informed by embedding a representation of the user information that has been obtained so far (e.g., product interest, celebrity interests) and comparing the resulting embedding with previously stored embeddings representing products or content in a vector database (e.g., vector database 120). The recommendations may be further informed by pre-training or prompting the LLM 130 to constrain the product or content recommendations, such as by limiting recommended products to a particular brand or limiting recommended content to a particular content provider.

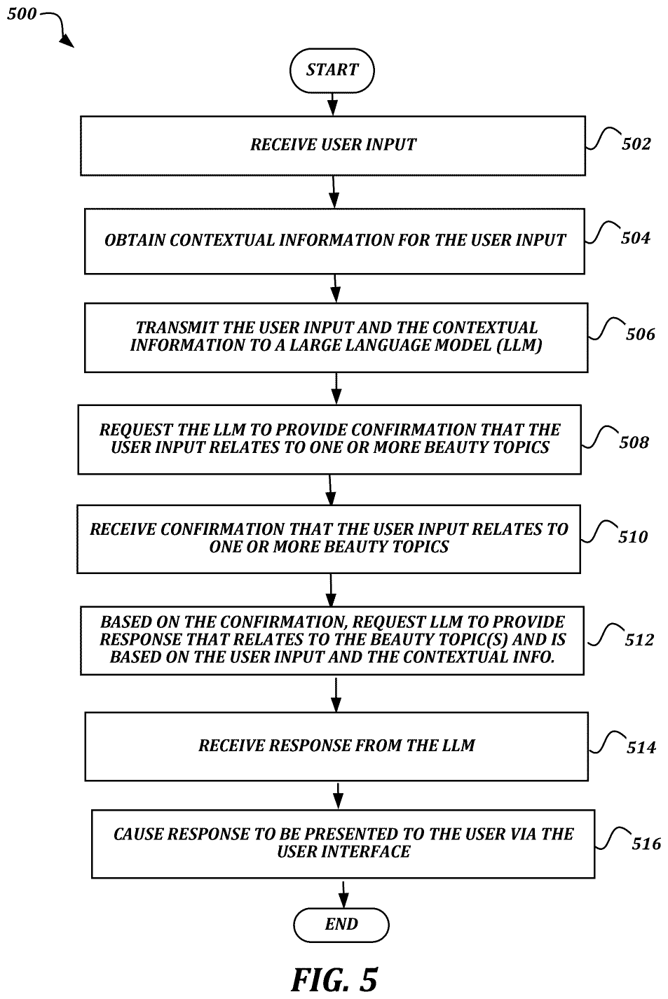

FIG. 5 is a flowchart that illustrates an example embodiment of a method of using an LLM to obtain responses to user input on beauty topics. The method 500 is implemented by a computer system. The method 500 may be implemented by one or more components of the system 100 depicted in FIG. 1, such as the back-end server system 110, or by some other computing device or system.

From a start block, the method 500 proceeds to block 502, where the computer system receives user input. In some embodiments, the user input is provided by a user via a user interface presented at a client computing device, such as user interface 400. The user input can be obtained in various ways, such as by obtaining text entered into a text input box or translating voice input into text. The process 500 proceeds to process block 504, where the computer system obtains contextual information for the user input. In some embodiments, the contextual information is provided in the form of prompts to provide context for the question or statement, such as special definitions or constraints (e.g., classification definitions, product recommendation constraints, etc.) to be considered by an LLM, user profile information (e.g., user preferences, demographics, skin characteristics, products used, etc.), summaries of past conversations, or other contextual information. The process 500 proceeds to process block 506, where the computer system transmits the user input and the contextual information to the LLM. In some embodiments, the computer system transmits user input obtained directly from a user interface (e.g., text input from a text input box). In some embodiments, the computer system transmits user input that has been modified or translated into a different form (e.g., text generated from voice input).

The process 500 proceeds to process block 508, where the computer system requests the LLM to provide confirmation that the user input relates to one or more beauty topics. The process 500 proceeds to process block 510, where the computer system receives confirmation that the user input relates to the beauty topic(s). In some embodiments, requesting the LLM to provide the confirmation that the user input relates to the beauty topic(s) comprises requesting the LLM to provide one or more classifications of the user input. In some embodiments, receiving the confirmation that the user input relates to the beauty topic(s) comprises receiving the classification(s) of the user input from the LLM. In such embodiments, the one or more classifications indicate that the user input relates to one or more beauty topics. In some embodiments, requesting the LLM to provide one or more classifications of the user input comprises requesting the LLM to provide a first classification of the user input, receiving the first classification of the user input from the LLM, wherein the first classification indicates that the user input relates to the one or more beauty topics, and responsive to the first classification indicating that the user input relates to the one or more beauty topics, requesting the LLM to provide a second classification of the user input that further defines the one or more beauty topics. In an illustrative scenario, requesting the LLM to provide the response to the user input is based on both the first classification and the second classification.

The process 500 proceeds to process block 512 where, based on the confirmation, the computer system requests the LLM to provide a response that relates to the beauty topic(s) and is based on the user input and the contextual information. At process block 514, the computer system receives the response from the LLM, and at process block 516, the computer system causes the response to be presented to the user via the user interface. The response may include text, graphical icons, links, videos, images, audio such as synthesized speech, other information, or combinations of such information. In some embodiments, the response comprises text presented to the user in a chat interface, one or more product recommendations, one or more content recommendations, one or more care routine recommendations, or a combination thereof. Such recommendations may be presented as text, graphical icons, links, videos, images, or the like.

FIG. 6 is a block diagram that illustrates aspects of an exemplary computing device 600 appropriate for use with embodiments of the present disclosure. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, LTE, 5G, WiMAX, Bluetooth, and/or the like.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media. In an embodiment, computer-readable media are used to store data for use by programs.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, USB, or other suitable connections protocols using wireless or physical connections. Similarly, the computing device 600 may also include output devices such as a display, speakers, printer, etc. Since these devices are well known in the art, they are not illustrated or described further herein.

### Extensions and Alternatives

Many alternatives to the systems and devices described herein are possible. For example, individual modules or subsystems may be separated into additional modules or subsystems or combined into fewer modules or subsystems. As another example, modules or subsystems may be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein may be modified to accommodate different hardware components, combinations, or arrangements. Further, although some examples in the present disclosure include descriptions of specific usage scenarios, techniques and tools described herein may be modified to accommodate different usage scenarios. Functionality that is described as being implemented in software may instead be implemented in hardware, or vice versa.

Many alternatives to the techniques described herein are possible. For example, processing stages in the various techniques may be separated into additional stages or combined into fewer stages. As another example, processing stages in the various techniques may be omitted or supplemented with other techniques or processing stages. As another example, processing stages that are described as occurring in a particular order may instead occur in a different order. As another example, processing stages that are described as being performed in a series of steps may instead be handled in a parallel fashion, with multiple modules or software processes concurrently handling one or more of the illustrated processing stages.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations. For example, information or user interface elements depicted as being presented simultaneously on a single page or screen may also be presented at different times, on different pages or screens, etc. As another example, some information or user interface elements may be presented conditionally depending on previous input, user preferences, or the like.

While illustrative embodiments have been illustrated and described, it will be appreciated that various changes can be made therein without departing from the spirit and scope of the invention.

The embodiments of the invention in which an exclusive property or privilege is claimed are defined as follows:

1. A non-transitory computer-readable medium having stored thereon instructions configured to, when executed by one or more computing devices of a computer system, cause the computer system to perform operations comprising:
transmitting user input and contextual information for the user input to a large language model (LLM);
requesting the LLM to provide a confirmation that the user input relates to one or more beauty topics;
receiving the confirmation that the user input relates to the one or more beauty topics from the LLM;
based on the confirmation, requesting the LLM to provide a response to the user input to be presented to a user, wherein the response relates to the one or more beauty topics and is based at least in part on the user input and the contextual information; and
receiving the response from the LLM.

2. The computer-readable medium of claim 1, wherein requesting the LLM to provide the confirmation that the user input relates to the one or more beauty topics comprises requesting the LLM to provide one or more classifications of the user input, wherein receiving the confirmation that the user input relates to the one or more beauty topics comprises receiving the one or more classifications of the user input from the LLM, and wherein the one or more classifications indicate that the user input relates to one or more beauty topics.

3. The computer-readable medium of claim 2, wherein requesting the LLM to provide one or more classifications of the user input comprises:
requesting the LLM to provide a first classification of the user input;
receiving the first classification of the user input from the LLM, wherein the first classification indicates that the user input relates to the one or more beauty topics; and
responsive to the first classification indicating that the user input relates to the one or more beauty topics, requesting the LLM to provide a second classification of the user input that further defines the one or more beauty topics,
wherein requesting the LLM to provide the response to the user input is based on both the first classification and the second classification.

4. The computer-readable medium of claim 1, wherein the user input includes text input or voice input.

5. The computer-readable medium of claim 1, the operations further comprising requesting the LLM to provide a summary of the user input.

6. The computer-readable medium of claim 5, the operations further comprising:
receiving the summary of the user input from the LLM;
generating a vector representation of the user input.

7. The computer-readable medium of claim 6, the operations further comprising:
comparing the vector representation of the user input with vector representations of other vector representations in a vector database; and
identifying a near-neighbor match for the vector representation of the user input among the other vector representations in the vector database.

8. The computer-readable medium of claim 1, the operations further comprising:
obtaining a digital model of a face of the user; and
requesting the LLM to generate a product recommendation or a care routine recommendation based at least in part on the digital model of the face.

9. The computer-readable medium of claim 8, wherein the digital model of the face includes a plurality of skin features including blemish information, hyper-pigmentation information, clinical signs, skin concern information, skin texture information, skin tone information, or a combination thereof.

10. A computer-implemented method comprising, by a computer system:
transmitting user input and contextual information for the user input to a large language model (LLM);
requesting the LLM to provide a confirmation that the user input relates to one or more beauty topics;
receiving the confirmation that the user input relates to the one or more beauty topics from the LLM;
based on the confirmation, requesting the LLM to provide a response to the user input to be presented to a user, wherein the response relates to the one or more beauty topics and is based at least in part on the user input and the contextual information; and
receiving the response from the LLM.

11. The method of claim 10, wherein requesting the LLM to provide the confirmation that the user input relates to the one or more beauty topics comprises requesting the LLM to provide one or more classifications of the user input, wherein receiving the confirmation that the user input relates to the one or more beauty topics comprises receiving the one or more classifications of the user input from the LLM, and wherein the one or more classifications indicate that the user input relates to one or more beauty topics.

12. The method of claim 11, wherein requesting the LLM to provide one or more classifications of the user input comprises:
requesting the LLM to provide a first classification of the user input;
receiving the first classification of the user input from the LLM, wherein the first classification indicates that the user input relates to the one or more beauty topics; and
responsive to the first classification indicating that the user input relates to the one or more beauty topics, requesting the LLM to provide a second classification of the user input that further defines the one or more beauty topics,
wherein requesting the LLM to provide the response to the user input is based on both the first classification and the second classification.

13. The method of claim 10 further comprising:
requesting the LLM to provide a summary of the user input;
receiving the summary of the user input from the LLM; and
generating a vector representation of the user input.

14. The method of claim 13 further comprising:
comparing the vector representation of the user input with vector representations of other vector representations in a vector database; and
identifying a near-neighbor match for the vector representation of the user input among the other vector representations in the vector database.

15. The method of claim 10 further comprising:
obtaining a digital model of a face of the user; and
requesting the LLM to generate a product recommendation or a care routine recommendation based at least in part on the digital model of the face.

16. The method of claim 15, wherein the digital model of the face includes a plurality of skin features including blemish information, hyper-pigmentation information, skin texture information, skin tone information, or a combination thereof.

17. A computer system comprising a processor and a non-transitory computer-readable medium having stored thereon instructions configured to, when executed by one or more computing devices of a computer system, cause the computer system to perform operations comprising:
obtaining user input from a client computing device;
obtaining contextual information for the user input;
transmitting the user input and the contextual information for the user input to a large language model (LLM);
requesting the LLM to provide one or more classifications of the user input;
receiving the one or more classifications of the user input from the LLM, wherein the one or more classifications indicate that the user input relates to one or more beauty topics;
based on the one or more classifications, requesting the LLM to provide a response to be presented to a user, wherein the response is based at least in part on the user input and the contextual information; and
receiving the response from the LLM.

18. The computer system of claim 17, wherein requesting the LLM to provide one or more classifications of the user input comprises:
requesting the LLM to provide a first classification of the user input;
receiving the first classification of the user input from the LLM, wherein the first classification indicates that the user input relates to the one or more beauty topics; and
responsive to the first classification indicating that the user input relates to the one or more beauty topics, requesting the LLM to provide a second classification of the user input that further defines the one or more beauty topics,
wherein requesting the LLM to provide the response to the user input is based on both the first classification and the second classification.

19. The computer system of claim 17, the operations further comprising:
requesting the LLM to provide a summary of the user input;
receiving the summary of the user input from the LLM;
generating a vector representation of the user input;
comparing the vector representation of the user input with vector representations of other vector representations in a vector database; and
identifying a near-neighbor match for the vector representation of the user input among the other vector representations in the vector database.

20. The computer system of claim 17, wherein the client computing device comprises a camera, the operations further comprising:
causing the client computing device to request activation of the camera to capture one or more digital images;
receiving the one or more captured digital images;
generating a digital model of the face of the user based at least in part on the one or more captured digital images; and
requesting the LLM to generate a product recommendation or a care routine recommendation based at least in part on the digital model of the face.
